(19) United States
(12) Patent Application Publication
(10) Pub. No.: US 2016/0122618 A1
(43) Pub. Date: May 5, 2016

(54) COMPOSITIONS INCLUDING A PARTICULATE BRIDGING AGENT AND FIBERS AND METHODS OF TREATING A SUBTERRANEAN FORMATION WITH THE SAME

(71) Applicant: HALLIBURTON ENERGY SERVICES, INC., Houston, TX (US)

(72) Inventors: Philip D. Nguyen, Houston, TX (US); Feng Liang, Cypress, TX (US); Tingji Tang, Spring, TX (US)

(21) Appl. No.: 14/896,414

(22) PCT Filed: Aug. 22, 2013
(86) PCT No.: PCT/US13/56249

§ 371 Date: Dec. 7, 2015

(51) Int. Cl. C09K 8/516; E21B 43/16; E21B 43/26; C09K 8/70; C09K 8/80

(52) U.S. Cl. CPC C09K 8/516; C09K 8/70; C09K 8/80; E21B 43/26; E21B 43/16; C09K 2208/08; C09K 2208/18

(57) ABSTRACT

The present invention relates to compositions including a particulate bridging agent and fibers, and methods of treating a subterranean formation with the same. In various embodiments, the present invention provides a method of treating a subterranean formation that includes obtaining or providing a composition including a particulate bridging agent and fibers. The method includes placing the composition in a subterranean formation. The method includes forming within the formation a bridging agent-fiber diverter. The bridging agent-fiber diverter is formed from the composition including the bridging agent and the fibers.

### BACKGROUND OF THE INVENTION

When placing fluids in subterranean formations during oilfield operations, fluid loss into the formation can be a major concern. Fluid loss can reduce the efficiency of the fluid placement with respect to time, fluid volume, and equipment. Fluid loss can be useful during a wide variety of operations, such as for example, drilling, drill-in, completion, stimulation (e.g., hydraulic fracturing, matrix dissolution), sand control (e.g., gravel packing, frac-packing, and sand consolidation), diversion, scale control, and water control.

Hydraulic fracturing is an important technique in the oilfield that includes placing or extending channels from the wellbore to the reservoir. This operation includes hydraulically injecting a fracturing fluid into a wellbore penetrating or adjacent to a petroleum-producing subterranean formation and forcing the fracturing fluid against the surrounding subterranean formation by pressure. The subterranean material is forced to crack, creating or enlarging one or more fractures. Proppant can be placed in fractures to prevent or reduce closure. The fractures can provide flow or can provide improved flow of the recoverable fluids from the formation, such as petroleum materials.

In subterranean formations having multiple zones, a fracturing fluid will predominantly flow through the zone of least resistance, which may prevent effective fracturing of a desired zone. A diverter can be used to bridge off one or more perforations, fractures, or flow pathways to control which zone is fractured. Mechanical diverters such as bridge plugs need sufficient space in the wellbore for insertion of the apparatus into a desired subterranean location, and can be sensitive to reduced diameter caused by, for example, casing patches and irregularities caused by tectonic movement. Additionally mechanical diversion techniques generally require the use of a different rig at the surface, which can sacrifice efficiency. An acid used to remove acid-soluble chemical diverters can damage equipment as well as the producing formation. Water-soluble chemical diverters can require long time periods for dissolution, and can have a limited range of useful densities.

### SUMMARY OF THE INVENTION

In various embodiments, the present invention provides a method of treating a subterranean formation. The method includes obtaining or providing a composition. The composition includes a particulate bridging agent and fibers. The method includes placing the composition in a subterranean formation. The method also includes forming a bridging agent-fiber diverter within the formation. The bridging agent-fiber diverter is formed from the composition including the particulate bridging agent and the fibers.

In various embodiments, the present invention provides a method of treating a subterranean formation. The method includes obtaining or providing a composition including a particulate bridging agent, fibers, and a proppant. The method includes placing the composition in a subterranean formation.

In various embodiments, the present invention provides a method of hydraulic fracturing. The method includes obtaining or providing a composition including a self-degrading particulate bridging agent and fibers. The method includes placing the composition in a subterranean formation. The method includes forming from the composition within the formation a bridging agent-fiber self-degrading diverter. The bridging agent-fiber self-degrading diverter is formed from the composition including the self-degrading particulate bridging agent and the fibers. The diverter is formed within the subterranean formation in at least one of a fracture, perforation, flow pathway, and an area surrounding the same. The method includes placing a hydraulic fracturing fluid in the subterranean formation. The method includes performing a hydraulic fracturing operation in the subterranean formation with the hydraulic fracturing fluid. During the hydraulic fracturing operation the bridging agent-fiber diverter substantially diverts the fracturing fluid away from the fracture, perforation, or flow pathway. The method also includes allowing the diverter to self-degrade.

In various embodiments, the present invention provides a system including a composition that includes a particulate bridging agent and fibers. The system also includes a subterranean formation including the composition therein.

In various embodiments, the present invention provides a system including a bridging agent-fiber diverter. The system also includes a subterranean formation including the diverter therein.

In various embodiments, the present invention provides a composition for treatment of a subterranean formation. The composition includes a particulate bridging agent and fibers.

In various embodiments, the present invention provides a diverter for fluid loss control in a subterranean formation. The diverter includes a bridging agent-fiber diverter.

In various embodiments, the present invention provides a method of preparing a composition for treatment of a subterranean formation. The method includes forming a composition that includes a particulate bridging agent and fibers.

Various embodiments of the present invention have certain advantages over other compositions and methods for controlling fluid loss downhole, at least some of which are unexpected. For example, in some embodiments the combination of bridging agent particulates and fibers in the composition can bridge off perforations, fractures, open hole sections, and other flow pathways more effectively and more efficiently than other diverting compositions and techniques. In some embodiments, the bridging agent particulates and the fibers can interact synergistically when forming a diverter or filter cake in a desired location downhole, enabling diversion on a large variety of subterranean formation geometries that is more effective, faster, and easier to remove as compared to other diverting compositions and techniques. By bridging off more effectively and efficiently, the compositions and methods of various embodiment can provide an overall higher efficiency in performing downhole operations that require fluid loss control. In some embodiments, the composition can be formed more easily and from more readily available and inexpensive materials as compared to other diverting compositions.

In some embodiments, the composition is self-degrading, e.g., can dissolve after treatment with no intervention, and therefore avoids the disadvantages associated with chemical diverters that require a separate treatment. In some embodiments, by avoiding a separate treatment step for removal, time and resources can be saved and a subsequent downhole operation can be initiated more quickly, leading to a more efficient operation overall. In some embodiments, by avoiding an acid degradation step, the method can produce less damage to equipment and the surrounding formation. In some embodiments, by avoiding the lengthy passage of time required by some water-soluble chemical diverters, a downhole operation such as hydraulic fracturing of multiple zones can be completed more quickly and efficiently, thereby resulting in more rapid initiation of production from the formation.

In some embodiments, the composition and method can help to ensure that none or fewer fractures or perforation clusters are bypassed during fracturing. In some embodiments, the composition and method can allow distribution of proppant more evenly with the use of fewer plugs than required by other methods. In some embodiments, the composition and method can be used to form proppant pillars or channels, which can increase production. In some embodiments, the composition and method can be used for developing extremely complex fracture networks for more complete recovery and higher production rates. In some embodiments, the composition can be used to form spacer fluids or as fracturing fluids to help suspend proppants more effectively than other compositions due to synergistic proppant-suspending abilities of the fibers and the bridging agent particles. In some embodiments, hydraulic fracturing using proppant and the composition including the fibers and bridging agent particles can at least one of ensure diverters that may already be in place continue to divert fracturing fluid as intended by contributing to the filter cake as needed, form new diverters in areas of highest permeability to help keep the fracturing treatment focused on areas of lower permeability, and effectively maintain the suspension of proppant.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a bridging agent-fiber diverter, in accordance with various embodiments of the present invention.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

Selected substituents within the compounds described herein are present to a recursive degree. In this context, “recursive substituent” means that a substituent may recite another instance of itself or of another substituent that itself recites the first substituent. Recursive substituents are an intended aspect of the disclosed subject matter. Because of the recursive nature of such substituents, theoretically, a large number may be present in any given claim. One of ordinary skill in the art of organic chemistry understands that the total number of such substituents is reasonably limited by the desired properties of the compound intended. Such properties include, by way of example and not limitation, physical properties such as molecular weight, solubility, and practical properties such as ease of synthesis. Recursive substituents can call back on themselves any suitable number of times, such as about 1 time, about 2 times, 3, 4, 5, 6, 7, 8, 9, 10, 15, 20, 30, 50, 100, 200, 300, 400, 500, 750, 1000, 1500, 2000, 3000, 4000, 5000, 10,000, 15,000, 20,000, 30,000, 50,000, 100,000, 200,000, 500,000, 750,000, or about 1,000,000 times or more.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” as used herein refers to but is not limited to any carbon-containing functional group. For example, an oxygen-containing group such as alkoxy groups, aryloxy groups, aralkyloxy groups, oxo(carbonyl) groups, carboxyl groups including carboxylic acids, carboxylates, and carboxylate esters; a sulfur-containing group such as alkyl and aryl sulfide groups; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen (in examples that include other carbon atoms) or a carbon-based moiety, and wherein the carbon-based moiety can itself be further substituted.

The term “substituted” as used herein refers to an organic group as defined herein or molecule in which one or more hydrogen atoms contained therein are replaced by one or more non-hydrogen atoms. The term “functional group” or “substituent” as used herein refers to a group that can be or is substituted onto a molecule, or onto an organic group. Examples of substituents or functional groups include, but are not limited to, a halogen (e.g., F, Cl, Br, and I); an oxygen atom in groups such as hydroxyl groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxylamines, nitriles, nitro groups, N-oxides, hydrazides, azides, and enamines; and other heteroatoms in various other groups. Non-limiting examples of substituents J that can be bonded to a substituted carbon (or other) atom include F, Cl, Br, I, OR, OC(O)N(R′)₂, CN, NO, NO₂, ONO₂, azido, CF₃, OCF₃, R′, O (oxo), S (thiono), C(O), S(O), methylenedioxy, ethylenedioxy, N(R)₂, SR, SOR, SO₂R′, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R wherein R can be hydrogen or a carbon-based moiety, and wherein the carbon-based moiety can itself be further substituted; for example, wherein R can be hydrogen, alkyl, acyl, cycloalkyl, aryl, aralkyl, heterocyclyl, heteroaryl, or heteroarylalkyl, wherein any alkyl, acyl, cycloalkyl, aryl, aralkyl, heterocyclyl, heteroaryl, or heteroarylalkyl or R can be independently mono- or multi-substituted with J; or wherein two R groups bonded to a nitrogen atom or to adjacent nitrogen atoms can together with the nitrogen atom or atoms form a heterocyclyl, which can be mono- or independently multi-substituted with J.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case wherein the carbonyl carbon atom is bonded to a hydrogen, the group is a “formyl” group, an acyl group as the term is defined herein. An acyl group can include 0 to about 12-20 or 12-40 additional carbon atoms bonded to the carbonyl group. An acyl group can include double or triple bonds within the meaning herein. An acryloyl group is an example of an acyl group. An acyl group can also include heteroatoms within the meaning here. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” as used herein refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups such as those listed herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is an alkoxy group within the meaning herein. A methoxyethoxy group is also an alkoxy group within the meaning herein, as is a methylenedioxy group in a context where two adjacent atoms of a structure are substituted therewith.

The terms “halo” or “halogen” or “halide,” as used herein, by themselves or as part of another substituent mean, unless otherwise stated, a fluorine, chlorine, bromine, or iodine atom, preferably, fluorine, chlorine, or bromine.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” as used herein refers to a functional group or molecule that includes carbon and hydrogen atoms. The term can also refer to a functional group or molecule that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” as used herein refers to a liquid that can dissolve a solid, liquid, or gas. Nonlimiting examples of solvents are silicones, organic compounds, water, alcohols, ionic liquids, and supercritical fluids.

The term “room temperature” as used herein refers to a temperature of about 15° C. to 28° C.

As used herein, “degree of polymerization” is the number of repeating units in a polymer.

As used herein, the term “polymer” refers to a molecule having at least one repeating unit, and can include copolymers.

The term “copolymer” as used herein refers to a polymer that includes at least two different monomers. A copolymer can include any suitable number of monomers.

The term “downhole” as used herein refers to under the surface of the earth, such as a location within or fluidly connected to a wellbore.

As used herein, the term “drilling fluid” refers to fluids, slurries, or muds used in drilling operations downhole, such as the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid, or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “production fluid” refers to fluids or slurries used downhole during the production phase of a well. Production fluids can include downhole treatments designed to maintain or increase the production rate of a well, such as perforation treatments, clean-up treatments, or remedial treatments.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments downhole. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore; placing a material in a subterranean formation can include contacting the material with any section of a wellbore or with any subterranean region in fluid contact therewith. Subterranean materials can include any materials placed into the wellbore such as cement, drill shafts, liners, tubing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

As used herein “treatment of a subterranean formation” can include any activity directed to extraction of water or petroleum materials from a subterranean petroleum- or water-producing formation or region, for example, including drilling, stimulation, hydraulic fracturing, clean-up, acidization, completion, cementing, remedial treatment, abandonment, and the like.

As used herein, a “flow pathway” downhole can include any suitable subterranean flow pathway through which two subterranean locations are in fluid connection. The flow pathway can be sufficient for petroleum or water to flow from one subterranean location to the wellbore, or vice-versa. A flow pathway can include at least one of a hydraulic fracture, a fluid connection across a screen, across a gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

As used herein “diverter” refers to a material having a blocking effect on fluids in a subterranean formation and which can be substantially removed later. Diverters can help to focus stimulation treatments on areas requiring the most treatment.

### Method of Treating a Subterranean Formation.

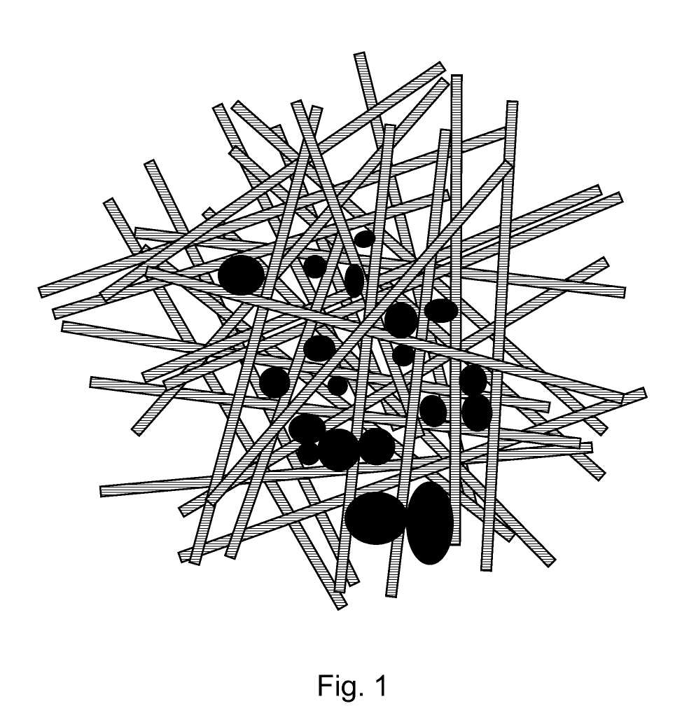

Efficient suspension of proppant during fracturing operations can increase the overall efficiency and effectiveness of the operation. Longer horizontal completions have increased the desire for diverting systems for improving completion efficiency. In various embodiments, a combination of particulates and fibers can be used to efficiently suspend proppants or to achieve diversion. For example, in various embodiments, bridging agent particulates and fibers can combine together as shown in FIG. 1 to form an effective diverter that can provide more effective and efficient fluid loss control than particulates or fibers alone. In some embodiments, a composition including the bridging agent particulates and fibers can provide a more efficient and effective proppant suspension than the particulates or fibers alone.

In some embodiments, the present invention provides a method of treating a subterranean formation. In some embodiments, the method can be a method of fluid loss control. In some embodiments, the method can be a method of hydraulic fracturing. The method includes obtaining or providing a composition including a particulate bridging agent and fibers, such as a suspension or slurry of the particulate bridging agent and the fibers. In some embodiments, the composition can be a fluid loss control composition. In some embodiments, the composition can be a hydraulic fracturing fluid. In some embodiments, the composition can be a well drill-in and servicing fluid. The obtaining or providing of the composition can occur at any suitable time and at any suitable location. The obtaining or providing of the composition can occur above the surface. The obtaining or providing of the composition can occur downhole. The composition can have any suitable viscosity. For example, the composition can have a viscosity at standard temperature and pressure of about 0.01 cP to about 15,000 cP, or about 0.02 cP to about 1,500 cP, or about 0.01 cP or less, or about 0.02 cP, 0.05, 0.1, 0.5, 1, 5, 10, 25, 50, 75, 100, 150, 200, 300, 400, 500, 600, 700, 800, 900, 1,000, 1,100, 1,200, 1,300, 1,400, 1,500, 1,750, 2,000, 3,000, 4,000, 5,000, 7,500, 10,000, 12,500, or about 15,000 cP or more.

The method also includes placing the composition in a subterranean formation. The placing of the composition in the subterranean formation can include contacting the composition and any suitable part of the subterranean formation, or contacting the composition and a subterranean material downhole, such as any suitable subterranean material. The subterranean formation can be any suitable subterranean formation. In some examples, the placing of the composition in the subterranean formation includes contacting the composition with or placing the composition in at least one of a fracture, at least a part of an area surrounding a fracture, a flow pathway, an area surrounding a flow pathway, and an area desired to be fractured. The placing of the composition in the subterranean formation can be any suitable placing, and can include any suitable contacting between the subterranean formation and the composition, wherein the particulate bridging agent and fibers can contact the subterranean formation together as a slurry, or can sit on or otherwise contact a surface of the subterranean formation in a greater concentration than is present in the surrounding solution. The placing of the composition in the subterranean formation can include at least partially placing the composition in an open-hole section, perforation, fracture, flow pathway, or an area surrounding the same, such as placing the composition in and around an region of the open-hole section, perforation, fracture or flow pathway that connects the area to the wellbore. The placing can occur in any suitable manner. For example, by pumping the composition downhole, the composition can flow into the open-hole section, perforation, fracture, or flow pathway, thereby placing or depositing the composition in and around a region of the area that connects the area to the wellbore and contacting the same.

In some embodiments, the placing of the composition in the subterranean formation can include placing proppant in the subterranean formation. The proppant can be part of the composition, such as being evenly distributed throughout the composition in a suspension, or the proppant can be substantially unmixed with the fibers and bridging agent particles, such as in a slurry adjacent to the composition including the fibers and particles. In one embodiment, a composition including fibers and bridging agent particles can be used to form spacer fluids adjacent to proppant suspensions during hydraulic fracturing operations, for example, to achieve channel fracturing or proppant pillars. In one embodiment, the composition including fibers and bridging agent particles can be injected into the formation as far-field diverting agents along with proppants. The presence of both bridging agent particles and fibers in the composition can enhance the suspension of proppants as compared to a corresponding composition having fibers alone. In some embodiments, a composition including bridging agent particles, fibers, and proppant can be used as a hydraulic fracturing fluid. The bridging agent particles and fibers can improve proppant transportation downhole, as well as provide proppant flowback control. In some embodiments, degradation features of the bridging agent can provide the benefits of the mixture of bridging agent particles and the fibers during transport and use of the proppant and also be easily removable at a later time.

The method can include hydraulic fracturing, such as a method of hydraulic fracturing to generate a fracture or flow pathway. The placing of the composition in the subterranean formation or the contacting of the subterranean formation and the hydraulic fracturing can occur at any time with respect to one another, for example, the hydraulic fracturing can occur at least one of before, during, and after the contacting or placing. In some embodiments, the contacting or placing occurs during the hydraulic fracturing, such as during any suitable stage of the hydraulic fracturing, such as during at least one of pre-pad stage (e.g., during injection of water with no proppant, and additionally optionally mid- to low-strength acid), a pad stage (e.g., during injection of fluid only with no proppant, with some viscosifier, such as to begin to break into an area and initiate fractures to produce sufficient penetration and width to allow proppant-laden later stages to enter) or a slurry stage of the fracturing (e.g., viscous fluid with proppant). The method can include performing a stimulation treatment at least one of before, during, and after placing the composition in the subterranean formation in the fracture, flow pathway, or an area surrounding the same. The stimulation treatment can be, for example, at least one of perforating, acidization, injecting of cleaning fluids, propellant stimulation, and hydraulic fracturing. In some embodiments, the stimulation treatment at least partially generates a fracture or flow pathway where the composition is placed or contacted, or the composition is placed in or contacted to an area surrounding the generated fracture or flow pathway.

The method includes forming a bridging agent-fiber diverter from the composition within the formation. The diverter can be any suitable diverter, such that the diverter effectively diverts a fluid away from an area downhole, such as the open-hole section, the perforation, the fracture, or the flow pathway that the composition was placed in or contacted to during the placing of the composition in the subterranean formation. The diverter is formed from the composition including the bridging agent and the fibers. The diverter includes at least some of the bridging agent from the composition and at least some of the fibers from the composition. The diverter can include any other suitable material present in the composition, such as undissolved materials. As the composition is placed in the subterranean formation and the composition flows into an open-hole section, perforation, fracture, or flow pathway, thereby placing or depositing the composition in and around a region of the area that connects the area to the wellbore (e.g. near wellbore location or a far field location such as about 10 ft to about 3000 ft, or about 10 ft to 1000 ft away from the wellbore) and contacting the same, the bridging agent and fibers can build up in spaces in the formation and then on themselves to begin to form the diverter in the regions connecting the areas to the wellbore, while pressure from the wellbore pushes liquid (e.g., liquids in the composition such as carrier fluid, or other liquids from the wellbore such as downhole fluids or produced fluids) through the accumulating bridging agent-fiber diverter. In some embodiments, the fibers allow for the more rapid initiation of build-up of the diverter in wider areas than particles alone, causing a more rapid initiation of diverter formation in areas that can be difficult or time consuming for diverter formation using particles alone.

As the surrounding liquid moves through the accumulating bridging agent-fiber diverter and into the permeable region, the accumulating diverter effectively filters other bridging agent particles and fibers, and other materials, out of the flowing solution, which can cause rapid and efficient accumulation that can surpass the accumulation rates possible with fibers or particles alone. In some embodiments, the diverter can be referred to as a filter cake. As the process continues, the bridging agent and the fibers continue to build up with fluid continuing to be forced through the accumulating diverter until the diverter is thick enough and nonporous enough that the pressure in the wellbore is substantially insufficient to move liquid into the open-hole section, perforation, fracture, or flow pathway. In some embodiments, the particles can fit into spaces formed by the fibers to form a more effective diverter than fibers alone. In some embodiments, the fibers can support the surrounding particles more effectively than particles alone, forming a stronger and more robust diverter than particles alone. From the surface, an increase in pressure may be observed as the diverter begins to successfully divert downhole fluids from the open-hole section, perforation, fracture, or flow pathway, allowing for convenient monitoring of the condition of the forming diverter downhole.

Multiple open-hole sections, perforations, fractures, flow pathways, or combinations thereof can have bridging agent-fiber diverters formed therein during one or more placements or applications of the composition to the subterranean formation. Since in some embodiments a driving force for the formation of the bridging agent-fiber diverter can be the flow of the composition from the wellbore into the open-hole section, perforation, fracture, or flow pathway that is desired to be treated, proximity of the areas is not required; therefore, in various embodiments, areas in different locations of the wellbore can be simultaneously treated and have bridging agent-fiber diverters formed therein. In some embodiments, the method can include selectively placing the composition in or contacting the composition with one or more selected highly permeable open-hole sections, perforations, fractures, or flow pathways in a wellbore having multiple highly permeable areas, to selectively form the bridging agent-fiber diverter on only one or more areas having high permeability. Any suitable method can be used to isolate the composition from one or more areas during placement of the composition in the subterranean formation to permit selective formation of one or more bridging agent-fiber diverters in wellbores having multiple high permeability areas, for example, including chemical or mechanical methods. In some embodiments, the composition can be injected downhole as near wellbore diverting agents.

The formed bridging agent-fiber diverter can be sufficient to substantially divert fluids away from the open-hole section, perforation, fracture, or flow pathway. Any suitable proportion of the fluids that would normally (e.g., without the diverter) flow through the one or more open-hole sections, perforations, fractures, or flow pathways, can be diverted by the diverter, for example, about 50 vol % to about 100 vol %, or about 80 vol % to about 99 vol %, or about 50 vol % or less, or about 55 vol %, 60, 65, 70, 75, 80, 85, 90, 91, 92, 93, 94, 95, 96, 97, 98, 99, 99.5, 99.9, 99.99, 99.999, 99.999.9 vol % or more.

In some embodiments, after forming the bridging agent-fiber diverter, the method includes placing a downhole fluid in the subterranean formation. In some examples, the downhole fluid can be placed in the subterranean formation before the degradation of the bridging agent-fiber diverter. In other examples, the downhole fluid can be placed in the subterranean formation after the degradation of the diverter. The downhole fluid can be any suitable downhole fluid, for example, an aqueous or oil-based fluid including a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof. The bridging agent-fiber diverter can substantially divert the downhole fluid away from at least one of an open-hole section, perforation, fracture, and flow pathway where the diverter was formed. Any suitable proportion of the fluids that would normally (e.g., without the diverter) flow through the one or more open-hole sections, perforations, fractures, or flow pathways, can be diverted by the diverter, for example, about 50 vol % to about 100 vol %, or about 80 vol % to about 99 vol %, or about 50 vol % or less, or about 55 vol %, 60, 65, 70, 75, 80, 85, 90, 91, 92, 93, 94, 95, 96, 97, 98, 99, 99.5, 99.9, 99.99, 99.999, 99.999.9 vol % or more. The method can include, after forming the bridging agent-fiber diverter, using a fracturing fluid placed in the subterranean formation (e.g., the downhole fluid) to hydraulically fracture the subterranean formation. The diverter can substantially divert the fracturing fluid away from the open-hole section, perforation, flow pathway, or fracture where the diverted was formed. The method can include, prior to the hydraulic fracturing and after forming the bridging agent-fiber diverter, placing an acidifying composition in the subterranean formation, which can help to lower the breakthrough pressure needed to fracture the desired non-diverted subterranean areas. In some embodiments, the hydraulic fracturing can be performed with proppant suspended in a composition including fibers or including a bridging agent and fibers. The fibers and bridging agent can help to ensure diverters in place continue to divert as intended, can form new diverters in areas of high permeability to help keep the stimulation treatment focused on areas of low permeability, and can effectively maintain the suspension of proppant.

Subsequent to hydraulic fracturing, the method can include placing more composition including bridging agent particles and fibers in the subterranean formation and the formation of one or more additional bridging agent-fiber diverters prior to substantial breakdown and loss of integrity of other bridging agent-fiber diverters formed. The method can include further treatments after formation of the additional diverters, such as acid treatments and hydraulic fracturing treatments. Embodiments of the present invention can include any suitable number of repetitions of bridging agent-fiber diverter formation and subsequent treatment. Repeating cycles of bridging agent-fiber diverter formation and downhole stimulation treatments can help to target stimulation treatment on the areas downhole that need treatments the most without losing treatment fluids to other areas downhole that are highly permeable, which can, for example, provide formation of complex and highly productive fracture patterns.

Various embodiments include degrading the bridging agent-fiber diverter. In some embodiments, degrading the bridging agent-fiber diverter includes permitting the bridging agent to self-degrade. The self-degradation can be any suitable self-degradation. For example, ambient solution, pH, temperature, and other conditions, can be adequate to enable degradation of the bridging agent-fiber diverter with the passage of time; the degradation can occur without addition of a particular solvent, without modification of the surrounding pH, and without modification of the temperature or other conditions.

In some embodiments, the self-degradation occur as a result of the influence of elements naturally present in the downhole formation over a period of time, which can lead to at least one of a physical breakdown, chemical breakdown, and dissolution of the bridging agent particles and optionally other components of the bridging agent-fiber diverter. Physical breakdown, chemical breakdown, and dissolution can be aided by pressure from fluids in the wellbore or pressure from fluids beyond the bridging agent-fiber diverter such as produced fluids. A physical breakdown can include a loss of physical integrity, such that a particle or fiber disintegrates into smaller particles or fibers. A chemical breakdown of the bridging agent or other components can include any suitable chemical breakdown, such as the cleavage of bonds, such as ionic or covalent bonds, and can include the transformation of one compound into another compound, such as the transformation of a polymer into a smaller polymer via intramolecular bond scission, or the transformation of a crosslinked polymer or other compound to a non-crosslinked or a less-crosslinked polymer or other compound via intramolecular bond breakage of crosslinks to the polymer or other compound. In some embodiments, a chemical breakdown can result in solid particles that substantially remain undissolved in the surrounding solution; in other embodiments, a chemical breakdown can result in particles that dissolve fully or at least partially in the surrounding solution. Dissolution can cause or increase the rate of physical breakdown of the bridging particle or other components to occur, and physical breakdown can cause or increase the rate of dissolution of the bridging particle or of other components.

In some embodiments, the degradation includes a breakdown of the integrity of the bridging agent-fiber diverter such that the diverter no longer diverts fluids from the open-hole section, perforation, fracture, or flow pathway where the diverter was located. For example, the bridging agent can break apart (e.g., via at least one of chemical breakdown, physical breakdown, and dissolution) such that the bridging agent-fiber diverter loses integrity. The bridging agent can dissolve such that the bridging agent-fiber diverter loses integrity. In some embodiments, the fibers can break apart or dissolve such that the bridging agent-fiber diverter loses integrity. In some embodiments, upon the loss of integrity, the bridging agent-fiber diverter can collapse, and can be free to be distributed, diluted, or washed away by downhole fluids or produced fluids. The collapse or loss of integrity of the bridging agent-fiber diverter can be aided or precipitated at least in part by pressure from fluids in the wellbore or pressure from fluids beyond the diverter such as produced fluids. In some embodiments, the degrading provides substantially complete removal of the bridging agent-fiber diverter from the subterranean formation, such as from the open-hole section, perforation, fracture, or flow pathway where the bridging agent-fiber diverter was formed, such as via loss of physical integrity, subsequent collapse of the diverter, and washing of the diverter components away from the location where the diverter was formed via downhole fluids or produced fluids. In some embodiments, the degrading substantially restores a pre-diverter-formation permeability to the fracture or flowpath where the bridging agent-fiber diverter was formed. The degrading can be irreversible, such that the degraded bridging agent-fiber diverter cannot reform another diverter or can only contribute to formation of other bridging agent-fiber diverters by the filtering action of diverters being formed, such as by capturing fibers or particulates that remain from the degraded bridging agent-fiber diverter.

In various embodiments, the method can include triggering the degrading. Degrading can be triggered by any suitable technique, such as at least one of allowing time to pass, heating, vibrating, changing surrounding pH, changing surrounding salinity, and changing the chemical environment. For example, degrading can be triggered via the passage of time, such as self-degradation or other degradation. The collapse of loss of integrity of the bridging agent-fiber diverter as caused by self-degradation or the passage of time can occur over any suitable duration, for example, about 5 minutes to about 5 days, or about 30 minutes to about 2 days, or about 1 hour to about 1 day, or about 3-20 hours, or about 5 minutes or less, or about 10 minutes, 30 minutes, 45 minutes, 1 hour, 1.5 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, 20 h, 21 h, 22 h, 23 h, 24 h, 1.5 days, 2 d, 2.5 d, 3 d, 4 d, or about 5 d or more. The triggering can include heating, such as via application of heat, or such as via heat that is naturally present downhole. The triggering can include changing the surrounding pH, such as by increasing the pH (e.g., basifying) or by decreasing the pH (e.g., acidifying). The triggering can include changing the surrounding salinity, such as by increasing or decreasing the concentration of one or more salts in the ambient solution, such as at least one of calcium chloride, sodium chloride, potassium chloride, magnesium chloride, calcium bromide, sodium bromide, potassium bromide, calcium nitrate, sodium formate, potassium formate, and cesium formate; for example, changing the surrounding salinity can include injecting a fresh water solution or a solution that has a particular concentration of salt adjacent the bridging agent-fiber diverter. The triggering can include changing the chemical environment, such as by changing the solvent adjacent to the bridging agent-fiber diverter, such as by changing the solvent to an aqueous solvent, to an organic solvent, or to an oil. Changing the chemical environment can include exposing the bridging agent-fiber diverter to produced fluids. In some embodiments, triggering the degradation can include self-degradation. In other embodiments, triggering the degradation can include non-self-degradation in addition to self-degradation in any suitable proportion, or can include substantially solely non-self-degradation.

### Fibers.

The fibers of the composition including the bridging agent particles and the fibers, and of the bridging agent-fiber diverter, can be any suitable fibers, such that the composition and diverter can be used as described herein. The composition or the bridging agent-fiber diverter can include one kind of fiber, or multiple kinds of fibers in any suitable proportion. In some embodiments, the fibers can be degradable, substantially non-self-degradable, or substantially non-degradable. In some examples, the fiber can be degradable, and the degradability of the fiber can be self-degradability (e.g., degrades as a result of the influence of elements naturally present in the downhole formation over a suitable period of time), or can be inducible degradability (e.g., triggerable, such as by at least one of allowing time to pass, heating, vibrating, changing surrounding pH, changing surrounding salinity, and changing the chemical environment). A degradable fiber can be at least one of physically degradable (e.g., loses physical integrity, such that disintegration into smaller materials occurs), chemically degradable (e.g., breakage of bonds or transformation into a different compound, such as cleavage of intramolecular or intermolecular bonds), or dissolvably degradable (e.g., at least part of the material dissolves in the surrounding solution; the dissolution can contribute to or be contributed to by physical degradation).

The fibers can be, for example, at least one of vegetable fibers (e.g., cotton, hemp, jute, flax, ramie, sisal, bagasse), wood fibers (e.g. from tree sources), human or animal fibers, mineral fibers (e.g., asbestos, wollastonite, palygorskite), metallic fibers (e.g., copper, nickel, aluminum), carbon fibers, silicon carbide fibers, fiberglass fibers, cellulose fibers, and polymer fibers. Examples of polymer fibers can include nylon fibers, polyethylene terephthalate fibers, poly(vinyl alcohol) fibers, polyolefin fibers (e.g., polyethylene or polypropylene), acrylic polyester fibers, aromatic polyamide fibers, elastomeric polymer fibers, and polyurethane fibers. In some embodiments, the fibers include at least one of polyamide fibers, polyethylene fibers, polypropylene fibers, and glass fibers (e.g., alkali-resistant glass fibers, or non-alkali-resistant glass fibers).

In various embodiments, the fibers can include at least one of a sizing agent, a coupling agent, a lubricant, an antistatic agent, an emulsifier, a wetting agent, and an antioxidant.

In some embodiments, the fibers can include a sizing agent, such as any suitable sizing agent. The sizing agent can coat any suitable proportion of the outside of each fiber. In some embodiment, the sizing agent can be a lipophilic sizing agent. A lipophilic sizing agent can give the fibers improved compatibility with and dispersability in fluids such as non-aqueous fluids such as oil-base fluids, synthetic-base fluids, invert-emulsion-base fluids, or combinations thereof. The lipophilic sizing agent can be non-polymeric. In some embodiments, the lipophilic sizing agent can be at least one of acetic anhydride, n-alkenyl isocyanate, a titanate, trichloro-s-triazine, and organosilanes having the structure (substituted or unsubstituted (C₁-C₃₀)hydrocarbyl)-Si—X₃, wherein X is independently selected from the group consisting of Cl, OMe, and OEt. In some embodiments, the lipophilic sizing agent is a lipophilic film-forming polymer. The lipophilic film-forming polymer can be at least one of a polyurethane, polystyrene, polyvinyl chloride, a polyolefin, a polyester, an epoxy resin, and copolymers thereof.

The fibers can have any suitable length. For example, the fibers can have a length of about 2 mm to about 30 mm, or about 6 mm to about 25 mm, or about 2 mm or less, or about 3, 4, 5, 6, 7, 8, 9, 10, 11, 12, 13, 14, 15, 16, 17, 18, 19, 20, 21, 22, 23, 24, 25, 26, 27, 28, 29, or about 30 mm or more. The fibers can have any suitable diameter. For example, the fibers can have a diameter of about 1 μm to about 0.5 mm, or about 10 μm to about 200 μm, or about 1 μm or less, 2.5, 5, 7.5, 10, 20, 30, 40, 50, 60, 70, 80, 90, 100, 110, 120, 130, 140, 150, 160, 170, 180, 190, 200 μm, 0.3 mm, 0.4 mm, or about 0.5 mm or more.

The fibers can be present in the composition in any suitable concentration. For example, the fibers can be present in the composition in a concentration of about 0.10 g/L to about 60 g/L of the composition, or about 0.50 g/L to about 30 g/L, or about 0.1 g/L or less, or about 0.25 g/L, 0.5, 1, 2, 3, 4, 5, 10, 15, 20, 30, 40, 50, 55, or about 60 g/L or more of the composition. The fibers any suitable proportion of the composition. For example, the fibers can be about 0.001 wt % to about 90 wt % of the composition, or about 0.01 wt % to about 60 wt % of the composition, or about 0.1 wt % to about 30 wt % of the composition, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85 wt %, or about 90 wt % of the composition or more. The fibers can form any suitable proportion of the bridging agent-fiber diverter. For example, the fibers can be about 0.001 wt % to about 99.999 wt % of the bridging agent-fiber diverter, or about 30 wt % to about 99 wt %, or about 50 wt % to about 99 wt %, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85, 90, 91, 92, 93, 94, 95, 96, 97, 98, 99, 99.9, 99.99 wt %, or about 99.999 wt % or more.

The fibers can have any suitable density. Fibers having densities near to the densities of the bridging agent or the carrier fluid can be used to help provide a well-distributed and stable slurry. For example, the fibers can have a density of about 0.5 g/cm³ to about 5 g/cm³, or about 1 g/cm³ to about 4 g/cm³, or about 0.5 g/cm³ or less, or about 0.6 g/cm³, 0.7, 0.8, 0.9, 1, 1.1, 1.2, 1.3, 1.4, 1.5, 1.6, 1.7, 1.8, 1.9, 2.0, 2.2, 2.5, 2.7, 3.0, 3.5, 4, or about 5 g/cm³ or more.

### Bridging Agent.

The bridging agent particles of the composition including the bridging agent particles and the fibers, and of the bridging agent-fiber diverter, can be any bridging agent particles, such that the composition and diverter can be used as described herein. The bridging agent-fiber diverter or the composition can include one type of bridging agent, or multiple types of bridging agents in any suitable proportion. The bridging agent can include one compound or multiple compounds. Each particle of the bridging agent can include one compound or more than one compound. The particles can have any suitable shape, for example, the particles can be at least one of platelets, shavings, flakes, ribbons, rods, strips, spheroids, toroids, pellets, and tablets.

The bridging agent can be a degradable polymer. The bridging agent can be a rehydratably-degradable compound, such that the agent is substantially non-degradable or only degrades slowly in the dehydrated state used in the composition, but in a hydrated state that can be obtained after treatment of the bridging agent-fiber diverter to sufficient sources of water becomes substantially degradable. The degradability of the polymer or of the rehydratably-degradable compound can be self-degradability (e.g., degrades as a result of the influence of elements naturally present in the downhole formation over a suitable period of time), or can be inducible degradability (e.g., triggerable, such as by at least one of allowing time to pass, heating, vibrating, changing surrounding pH, changing surrounding salinity, and changing the chemical environment). The degradable polymer or the rehydratable-degradable compound can be at least one of physically degradable (e.g., loses physical integrity, such that disintegration into smaller materials occurs), chemically degradable (e.g., breakage of bonds or transformation into a different compound, such as cleavage of intramolecular or intermolecular bonds), or dissolvably degradable (e.g., at least part of the material dissolves in the surrounding solution; the dissolution can contribute to or be contributed to by physical degradation). The chemical structure of a degradable bridging agent, e.g., the included functional groups, or the length of a polymeric degradable bridging agent, can be adjusted to attain the desired properties for the specific application, including the desired degradation properties.

In some embodiments, the bridging agent can include at least one polymer selected from the group consisting of a polysaccharide, chitin, chitosan, a protein, an orthoester, an aliphatic polyester, a polyglycolide, polylactide, a polylactide-polyglycolide copolymer, poly(vinyl alcohol), an esterified poly(vinyl alcohol), polycaprolactone, polyhydroxybutyrate, a polyanhydride, an aliphatic polycarbonate, a polyorthoester, a poly(amino acid), a poly(ethylene oxide), and a polyphosphazene, or a copolymer including monomers from at least two polymers chosen from the group.

In some embodiments, the bridging agent includes a polyester. For example, the bridging agent can include a polymer including a repeating unit having the structure

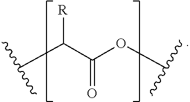

At each occurrence R can be independently a substituted or unsubstituted (C₁-C₃₀)hydrocarbyl at least one of interrupted and terminated by 0, 1, 2, or 3 of at least one of O, S, and substituted or unsubstituted N. At each occurrence R can be independently (C₁-C₁₀)alkyl. At each occurrence R can be independently selected from the group consisting of methyl, ethyl, and propyl. In some embodiments, R is methyl. The bridging agent can be polylactide, such as poly-L-lactide, poly-D-lactide, or poly(D,L-lactide). The polylactide can have an even distribution of D and L lactide (e.g. racemic), or the polylactide can have any suitable proportion of each, such as about 10 mol %, 20, 30, 40, 45, 55, 60, 70, 80, or about 90 mol % D with the remainder L. The polylactide can have any suitable degree of polymerization, such as about 50 to about 20,000, or about 75 to about 10,000.

In some embodiments, alone or in addition to a polyester such as a polylactide, the bridging agent includes, in anhydrous or hydrous form, boric oxide or magnesium oxide, or a borates or carbonate salt having as a counterion Na⁺, K⁺, Li⁺, Zn⁺, NH₄⁺, Ca²⁺, Mg²⁺, Zn²⁺, or Al³⁺. For example, the bridging agent can include, in anhydrous or hydrous form, at least one of sodium borate and calcium carbonate. In compositions including both polyester and the salt, any suitable proportion of the boric oxide, magnesium oxide, or carbonate or borate salt can be present with respect to the polyester; for example, the salt can be present in about 0.000.1 wt % of the polyester, or about 0.001 wt %, 0.005, 0.01, 0.05, 0.1, 0.5, 1, 2, 3, 4, 5, 10, 20, 30, 40, 50, 60, 70, 80, 90, 100, 125, 150, 175, 200, 250, 300, 400, or about 500 wt % or more of the polyester. In composition including salt with no polyester, the salt can be present in any suitable proportion of the composition, such as about 0.000.1 wt % to about 80 wt %, or about 0.001 wt % to about 50 wt %, or about 0.000.1 wt % or less, or about 0.001, 0.01, 0.1, 1, 2, 3, 4, 5, 10, 20, 30, 40, or about 50 wt % or more of the composition.

In some embodiments, alone or in addition to a polyester such as a polylatide, the bridging agent includes, in anhydrous form, a rehydratably degradable compound selected from the group consisting of anhydrous borax (e.g., anhydrous sodium tetraborate) and anhydrous boric acid. Any suitable proportion of the anhydrous borax or anhydrous boric acid can be present in the composition, such as about 0.000.1 wt % to about 80 wt %, or about 0.001 wt % to about 50 wt %, or about 0.000.1 wt % or less, or about 0.001, 0.01, 0.1, 1, 2, 3, 4, 5, 10, 20, 30, 40, or about 50 wt % or more of the composition.

In some embodiments, the bridging agent can include a polymer including a repeating unit having the structure

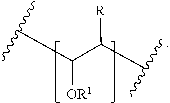

At each occurrence R can be independently a substituted or unsubstituted (C₁-C₃₀)hydrocarbyl at least one of interrupted and terminated by 0, 1, 2, or 3 of at least one of O, S, and substituted or unsubstituted N. At each occurrence R¹ is independently selected from the group consisting of H and —C(O)—R², wherein at each occurrence R² is independently substituted or unsubstituted (C₁-C₂₀)hydrocarbyl at least one of interrupted and terminated by 0, 1, 2, or 3 of at least one of O, S, and substituted or unsubstituted N. At each occurrence R can be independently (C₁-C₁₀)alkyl. The variable R can be H. At each occurrence the variable R¹ can be independently (C₁-C₁₀)alkyl. The bridging agent can include at least one of poly(vinyl alcohol), poly(vinyl acetate), poly(vinyl propanoate), poly(vinyl butanoate), poly(vinyl pentanoate), poly(vinyl hexanoate), poly(vinyl 2-methyl butanoate), poly(vinyl 3-ethylpentanoate), and poly(vinyl 3-ethylhexanoate). In some embodiments, the bridging agent can include a copolymer including a repeating unit formed from at least one of vinyl alcohol, vinyl acetate, vinyl propanoate, vinyl butanoate, vinyl pentanoate, vinyl hexanoate, vinyl 2-methyl butanoate, vinyl 3-ethylpentanoate, and vinyl 3-ethylhexanoate.

In some embodiments, the bridging agent can include a polyanhydride selected from the group consisting of poly(maleic anhydride), acetic formic anhydride, a poly((C₁-C₂₀)alkenoic(C₁-C₂₀)alkanoic anhydride) anhydride, a poly((C₁-C₂₀)alkenoic(C₁-C₂₀)alkenoic anhydride), poly(propenoic acid anhydride), poly(butenoic acid anhydride), poly(pentenoic acid anhydride), poly(hexenoic acid anhydride), poly(octenoic acid anhydride), poly(nonenoic acid anhydride), poly(decenoic acid anhydride), poly(acrylic acid anhydride), poly(fumaric acid anhydride), poly(methacrylic acid anhydride), poly(hydroxypropyl acrylic acid anhydride), poly(vinyl phosphonic acid anhydride), poly(vinylidene diphosphonic acid anhydride), poly(itaconic acid anhydride), poly(crotonic acid anhydride), poly(mesoconic acid anhydride), poly(citraconic acid anhydride), poly(styrene sulfonic acid anhydride), poly(allyl sulfonic acid anhydride), poly(methallyl sulfonic acid anhydride), or poly(vinyl sulfonic acid anhydride).

The bridging agent can form any suitable proportion of the composition. For example, the bridging agent can be about 0.001 wt % to about 90 wt % of the composition, or about 0.01 wt % to about 60 wt % of the composition, or about 0.1 wt % to about 30 wt % of the composition, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85 wt %, or about 90 wt % of the composition or more. The bridging agent can form any suitable proportion of the bridging agent-fiber diverter. For example, the bridging can be about 0.001 wt % to about 99.999 wt % of the bridging agent-fiber diverter, or about 30 wt % to about 99 wt %, or about 50 wt % to about 99 wt %, or about 0.001 wt % or less, or about 0.01 wt %, 0.1, 1, 2, 3, 4, 5, 10, 15, 20, 25, 30, 35, 40, 45, 50, 55, 60, 65, 70, 75, 80, 85, 90, 91, 92, 93, 94, 95, 96, 97, 98, 99, 99.9, 99.99 wt %, or about 99.999 wt % or more.

The bridging agent can have any suitable particle size, wherein particle size is the longest dimension of a particle, for example, about 0.1 μm to about 10 mm, or about 0.1 μm to about 1 mm, or about 1 mm to about 10 mm, or about 0.1 μm or less, or about or about 0.25 μm, 0.5 μm, 0.75 μm, 1 μm, 2.5 μm, 5 μm, 7.5 μm, 10 μm, 25 μm, 50 μm, 75 μm, 0.1 mm, 0.25 mm, 0.5 mm, 0.75 mm, 1 mm, 2 mm, 3 mm, 4 mm, 5 mm, 6 mm, 7 mm, 8 mm, 9 mm, or about 10 mm or more. In various embodiments, the bridging agent has at least two particle distributions, such that one particle distribution is about 0.1 μm to about 1 mm, or about 0.1 μm or less, or about 0.25 μm, 0.5 μm, 0.75 μm, 1 μm, 2.5 μm, 5 μm, 7.5 μm, 10 μm, 25 μm, 50 μm, 75 μm, 0.1 mm, 0.25 mm, 0.5 mm, 0.75 mm, or about 1 mm or more, and such that the other particle distribution is about 0.1 mm to about 10 mm, or about 1 mm to about 10 mm, or 0.1 mm, 0.25 mm, 0.5 mm, 0.75 mm, 1 mm, 2 mm, 3 mm, 4 mm, 5 mm, 6 mm, 7 mm, 8 mm, 9 mm, or about 10 mm or more.

### Other Components.

In addition to the bridging agent particles and the fibers, the composition or the bridging agent-fiber diverter can include any suitable additional components, in any suitable proportions, such that the composition can be used as described herein. The bridging agent-fiber diverter can include any component present in the composition, but generally only solid (non-liquid and non-dissolved) components of the composition are included in the diverter.

In some embodiments, the composition can include a carrier fluid. The carrier fluid can be any suitable carrier fluid; for example, at least one of water, brine, sea water, brackish water, flow back water, production water, oil, and an organic solvent. The carrier fluid can be any suitable proportion of the composition, such as about 30 wt % to about 99 wt % of the composition, about 60 wt % to about 99 wt %, or about 85 wt % to about 99 wt % of the composition, or about 30 wt % or less, or about 35 wt %, 40, 45, 50, 55, 60, 65, 70, 75, 80, 85, 90, 91, 92, 93, 94, 95, 96, 97, 98, or about 99 wt % or more of the composition.

The composition can include a viscosifier, such as a gel or crosslinked gel. The gel or crosslinked gel can be any suitable gel or crosslinked gel, such as at least one of a linear polysaccharide and a poly((C₂-C₁₀)alkenylene), wherein the (C₂-C₁₀)alkenylene is substituted or unsubstituted. The gel or crosslinked gel can include least one of poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly(hydroxyethyl methacrylate), acetan, alginate, chitosan, curdlan, a cyclosophoran, dextran, emulsan, a galactoglucopolysaccharide, gellan, glucuronan, N-acetyl-glucosamine, N-acetyl-heparosan, hyaluronic acid, indicant, kefiran, lentinan, levan, mauran, pullulan, scleroglucan, schizophyllan, stewartan, succinoglycan, xanthan, welan, starch, tamarind, tragacanth, guar gum, derivatized guar, gum ghatti, gum arabic, locust bean gum, cellulose, and derivatized cellulose. The gel or crosslinked gel can include cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar. The gel or crosslinked gel can form any suitable proportion of the composition, such as about 0.001 wt % to about 10 wt % of the composition, 0.01 wt % to about 0.6 wt %, about 0.13 wt % to about 0.30 wt %, or about 0.001 wt % or less, or about 0.005 wt %, 0.01, 0.05, 0.1, 0.2, 0.3, 0.4, 0.5, 0.6, 0.7, 0.8, 0.9, 1, 1.5, 2, 3, 4, 5, 6, 7, 8, 9, or about 10 wt % of the composition.

In some embodiments, the composition includes a crosslinker, such as one crosslinker or multiple crosslinkers. The crosslinker can be any suitable crosslinker, such as a crosslinking including at least one of chromium, aluminum, antimony, zirconium, titanium, calcium, boron, iron, silicon, copper, zinc, magnesium, and an ion thereof. In some examples, the crosslinker can be boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, or aluminum citrate. The crosslinker can be present in any suitable proportion of the composition, such as about 0.000.001 wt % to about 5 wt % of the composition, about 0.001 wt % to about 2 wt % of the composition, or about 0.000.001 wt % or less, or about 0.000.01 wt %, 0.000.1, 0.001, 0.01, 0.1, 1, 1.5, 2, 2.5, 3, 3.5, 4, 4.5, or about 5 wt % of the composition or more. The method can include crosslinking the gel or the crosslinked gel. In some embodiments, the crosslinking occurs above the surface. In some embodiments, the crosslinking occurs downhole, such as during or after placement of the composition in the subterranean formation.

The composition can include a fluid loss control additive. The fluid loss control additive can provide a degree of fluid loss control to the composition, in addition to the fluid loss control already provided by the composition without the additional component. The fluid loss control additive can be any suitable fluid loss control additive, such as at least one of starch, starch ether derivatives, hydroxyethylcellulose, and cross-linked hydroxyethyl cellulose. The fluid loss control additive can be present in any suitable amount, such as about 0.001 wt % to about 10 wt % of the composition, about 0.01 wt % to about 3 wt %, about 1 wt % to about 2 wt %, or about 0.001 wt % or less, or about 0.005, 0.01, 0.05, 0.1, 0.5, 1, 1.5, 2, 2.5, 3, 4, 5, 6, 7, 8, 9, or about 10 wt % or more of the composition.

The composition can include one or more breakers. In some embodiments, the breaker can be released upon degradation of the bridging agent-fiber diverter. In some embodiments, the breaker is encapsulated within a coating or a shell that breaks or dissolved when needed, such as after degradation of the bridging agent-fiber diverter. In embodiments including compositions that include fibers, bridging agent particles, and a proppant, such as for hydraulically fracturing while targeting areas not having the highest permeability (e.g., areas requiring more treatment), a breaker can conveniently be made available to the surrounding solution upon degradation of the one or more bridging agent-fiber diverters such that the viscous hydraulic fracturing fluid can be at least partially broken for more complete and more efficient recovery of the fracturing fluid at the conclusion of the hydraulic fracturing treatment. The breaker can be any suitable breaker; for example, the breaker can be a compound that includes a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion. In some examples, the breaker can be an oxidative breaker or an enzymatic breaker. An oxidative breaker can be at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion. An enzymatic breaker can be at least one of an alpha or beta amylase, amyloglucosidase, oligoglucosidase, invertase, maltase, cellulase, hemi-cellulase, and mannanohydrolase. The breaker can be any suitable proportion of the composition, such as about 0.001 wt % to about 30 wt % of the composition, or about 0.001 wt % or less, or about 0.005, 0.01, 0.05, 0.1, 0.5, 1, 2, 3, 4, 5, 10, 15, 20, 25, or about 30 wt % or more.

In various embodiments, the composition can include a plasticizer. The plasticizer can be any suitable plasticizer. In some examples, the plasticizer can be polyvinyl alcohol. In some examples, the plasticizer can be a polyester oligomer. For example, the plasticizer can include a oligomer including a repeating unit having the structure

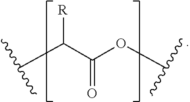

At each occurrence R can be independently a substituted or unsubstituted (C₁-C₃₀)hydrocarbyl at least one of interrupted and terminated by 0, 1, 2, or 3 of at least one of O, S, and substituted or unsubstituted N. At each occurrence R can be independently (C₁-C₁₀)alkyl. At each occurrence R can be independently selected from the group consisting of methyl, ethyl, and propyl. In some embodiments, R is methyl. The plasticizer can be a polylactide oligomer, such as a poly-L-lactide, poly-D-lactide, or a poly(D,L-lactide) oligomer. The polylactide can have an even distribution of D and L lactide (e.g. racemic), or the polylactide can have any suitable proportion of each, such as about 10 mol %, 20, 30, 40, 45, 55, 60, 70, 80, or about 90 mol % D with the remainder L. The polylactide can have any suitable degree of polymerization, such as about 2 to about 100, or about 3 to about 75. The plasticizer can be present in any suitable proportion of the composition, such as about 0.001 wt % to about 40 wt %, or about 0.001 wt % to about 20 wt %, or about 0.001 wt % or less, or about 0.01 wt %, 0.1, 1, 2, 3, 4, 5, 10, 15, 20, 25, 30, 35, or about 40 wt % or more.

The composition can include a tackifying agent. For example, the tackifying agent can be used to enhance the tightness and integrity of the formed bridging agent-fiber diverter. The tackifying agent can be present in the composition in any suitable proportion with respect to the bridging agent; for example, the tackifying agent can be present at about 0.001 wt % to about 30 wt % of the bridging agent, about 0.01 wt % to about 15 wt %, about 0.1 wt % to about 5 wt %, or about 0.001 wt %, 0.005, 0.01, 0.05, 0.1, 0.5, 1, 2, 3, 4, 5, 10, 15, 20, 25, or at about 30 wt % of the bridging agent or more. The tackifying agent can be in any suitable form, such as particles, flakes, ribbons, or fibers. The tackifying agent can be any suitable tackifying agent, such as a thermoplastic material including at least one of a polyolefin, a polyamide, a polyvinyl compound, a polyimide, a polyurethane, a polysulfone, a polycarbonate, a polyester, and a cellulose derivative. The tackifying agent can include a thermoplastic material including at least one of polyethylene polymer, copolymer or a fluorinated derivative thereof, a polypropylene polymer, copolymer, or a fluorinated derivative thereof, and a polybutylene polymer, copolymer, or a fluorinated derivative thereof. The tackifying agent can include a non-aqueous tackifying agent, an aqueous tackifying agent, a silyl-modified polyamide, and a reaction product of an amine and a phosphate ester.

In some embodiments, the tackifying agent can be a non-aqueous tackifying agent. The non-aqueous tackifying agent can be a condensation reaction product of polyacids and a polyamine, wherein examples of the polyacid can include trimer acids, synthetic acids produced from fatty acids, maleic acid, and acrylic acid. The non-aqueous tackifying agent can be a polyester, polycarbonate, polycarbamate, or a natural resin such as shellac. In some embodiments, the tackifying agent can be an aqueous tackifying agent. In some embodiments, the tackiness of an aqueous tackifying agent can be relatively low when placed onto a particulate, but can be activated (e.g., destabilized, coalesced, or reacted) to transform the compound into a sticky, tackifying compound at a desirable time. Such activation may occur before, during, or after the aqueous tackifying agent is placed in the subterranean formation. In some embodiments, a pretreatment may be first contacted with the surface of a particulate to prepare it to be coated with an aqueous tackifying agent. Aqueous tackifying agents can enhance the grain-to-grain contact between the individual particulates within the formation. Examples of aqueous tackifying agents can include polymers formed from at least one of acrylic acid, methacrylic acid, 2-acrylamido-2-methylpropane sulfonic acid, and esters thereof. In some embodiments, the tackifying agent can be a silyl-modified polyamide. The silyl-modified polyamide can be any suitable compound that can be produced by silylation of a polyamide. In some embodiments, the tackifying agent can be a reaction product of an amine and a phosphate ester. Suitable amines can include anilines, pyridines, pyrrole, pyrrolidine, indole, imidazole, quinoline, isoquinoline, pyrazine, quinoxaline, acridine, pyrimidine, quinazoline, substituted versions thereof, or mixtures or combinations thereof.

### Downhole Mixture or Composition.

The composition including the particulate bridging agent and the fibers can be combined with any suitable downhole fluid before, during, or after the placement of the composition in the subterranean formation or the contacting of the composition and the subterranean material. In some examples, the composition including the particulate bridging agent and the fibers is combined with a downhole fluid above the surface, and then the combined composition is placed in a subterranean formation or contacted with a subterranean material. In another example, the composition including the particulate bridging agent and the fibers is injected into a subterranean formation to combine with a downhole fluid, and the combined composition is contacted with a subterranean material or is considered to be placed in the subterranean formation. In various examples, at least one of prior to, during, and after the placement of the composition in the subterranean formation or contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.

In various embodiments, the method includes combining the composition including the particulate bridging agent and the fibers with any suitable downhole fluid, such as an aqueous or oil-based fluid including a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof, to form a mixture. The placement of the composition in the subterranean formation can include contacting the subterranean material and the mixture. The contacting of the subterranean material and the composition can include contacting the subterranean material and the mixture. A mixture that is placed in the subterranean formation or contacted with the subterranean material can include any suitable weight percent of the composition including the particulate bridging agent and the fibers, such as about 0.000.000.01 wt % to 99.999.99 wt %, 0.000.1-99.9 wt %, 0.1 wt % to 99.9 wt %, or about 20-90 wt %, or about 0.000.000.01 wt % or less, or about 0.000.001 wt %, 0.000.1, 0.001, 0.01, 0.1, 1, 2, 3, 4, 5, 10, 15, 20, 30, 40, 50, 60, 70, 80, 85, 90, 91, 92, 93, 94, 95, 96, 97, 98, 99, 99.9, 99.99, 99.999, 99.999.9, or about 99.999.99 wt % or more of the composition.

In some embodiments, the composition can include any suitable amount of any suitable material used in a downhole fluid. For example, the composition can include water, saline, aqueous base, oil, organic solvent, synthetic fluid oil phase, aqueous solution, alcohol or polyol, cellulose, starch, alkalinity control agents, density control agents, density modifiers, emulsifiers, dispersants, polymeric stabilizers, crosslinking agents, polyacrylamide, a polymer or combination of polymers, antioxidants, heat stabilizers, foam control agents, solvents, diluents, plasticizer, filler or inorganic particle, pigment, dye, precipitating agent, rheology modifier, oil-wetting agents, set retarding additives, surfactants, gases, weight reducing additives, heavy-weight additives, lost circulation materials, filtration control additives, dispersants, salts, fibers, thixotropic additives, breakers, crosslinkers, rheology modifiers, curing accelerators, curing retarders, pH modifiers, chelating agents, scale inhibitors, enzymes, resisn, water control materials, oxidizers, markers, Portland cement, pozzolana cement, gypsum cement, high alumina content cement, slag cement, silica cement fly ash, metakaolin, shale, zeolite, a crystalline silica compound, amorphous silica, hydratable clays, microspheres, pozzolan lime, or a combination thereof.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks penetrated and also to form a thin, low permeability filter cake, which temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g. barium sulfate), surfactants (e.g. betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g. silica), pigments, dyes, precipitating agents (e.g., silicates or aluminum complexes), and rheology modifiers such as thickeners or viscosifiers (e.g., xanthan gum). Any ingredient listed in this paragraph can be either present or not present in the mixture. The drilling fluid can be present in the mixture with the composition including the particulate bridging agent and the fibers in any suitable amount, such as about 1 wt % or less, about 2 wt %, 3, 4, 5, 10, 15, 20, 30, 40, 50, 60, 70, 80, 85, 90, 95, 96, 97, 98, 99, 99.9, 99.99, 99.999, or about 99.9999 wt % or more of the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 50:50 to about 95:5 by volume of oil phase to water phase. A substantially all oil mud includes about 100% liquid phase oil by volume; e.g., substantially no internal aqueous phase.

A pill is a relatively small quantity (e.g. less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including the particulate bridging agent and the fibers can form a useful combination with cement or cement kiln dust. The cement kiln dust can be any suitable cement kiln dust. Cement kiln dust can be formed during the manufacture of cement and can be partially calcined kiln feed which is removed from the gas stream and collected in a dust collector during a manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with embodiments of the present invention; for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in embodiments of the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt % to about 100 wt %, 0-95 wt %, 20-95 wt %, or about 50-90 wt %. A cement kiln dust can be present in an amount of at least about 0.01 wt %, or about 5 wt %-80 wt %, or about 10 wt % to about 50 wt %.

Optionally, other additives can be added to a cement or kiln dust-containing composition of embodiments of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the present invention can include a proppant, a resin-coated proppant, an encapsulated resin, or a combination thereof. A proppant is a material that keeps an induced hydraulic fracture at least partially open during or after a fracturing treatment. Proppants can be transported downhole to the fracture using fluid, such as fracturing fluid or another fluid. A higher-viscosity fluid can more effectively transport proppants to a desired location in a fracture, especially larger proppants, by more effectively keeping proppants in a suspended state within the fluid. Examples of proppants can include sand, gravel, glass beads, polymer beads, ground products from shells and seeds such as walnut hulls, and manmade materials such as ceramic proppant. In some embodiments, proppant can have an average particle size of about 0.15 mm to about 2.5 mm, about 0.25-0.43 mm, 0.43-0.85 mm, 0.85-1.18 mm, 1.18-1.70 mm, and 1.70-2.36 mm.

The composition can include a payload material. The payload can be deposited in any suitable downhole location. The method can include using the composition to deposit a payload material into a subterranean fracture. The subterranean fracture can be any suitable subterranean fraction. In some embodiments, the method includes forming the subterranean fracture; in other embodiments, the subterranean fracture is already formed. The payload material can be a proppant, or any other suitable payload material, such as a resin-coated proppant, a curable material, an encapsulated resin, a resin, a Portland cement, a pozzolana cement, a gypsum cement, a high alumina content cement, a slag cement, a silica cement, a cementitous kiln dust, fly ash, metakaolin, shale, zeolite, a set retarding additive, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, a density control agent, a density modifier, a surfactant, an emulsifier, a dispersant, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof.

### System.

In various embodiments, the present invention provides a system. The system can include a composition including a particulate bridging agent and fibers. The system can also include a subterranean formation including the composition therein.

In various embodiments, the present invention provides a system. The system can include a composition including a bridging agent-fiber diverter. The system can also include a subterranean formation including the diverter therein.

### Composition for Treatment of a Subterranean Formation.

Various embodiments provide a composition for treatment of a subterranean formation. The composition can be any suitable composition that can be used to perform an embodiment of the method for treatment of a subterranean formation described herein. The composition can be a fluid control composition, or a hydraulic fracturing composition. For example, the composition can include a particulate bridging agent and fibers. In some embodiments, the composition further includes proppant.

In some embodiments, the composition further includes a downhole fluid. The downhole fluid can be any suitable downhole fluid. In some embodiments, the downhole fluid is a composition for fracturing of a subterranean formation or subterranean material, or a fracturing fluid.

In some embodiments, the present invention provides a diverter for fluid loss control in a subterranean formation, including a bridging agent-fiber diverter. The diverter can be any bridging agent-fiber diverter described herein, such as can be formed using a composition including the bridging agent and the fibers.

### Method for Preparing a Composition for Treatment of a Subterranean Formation.

In various embodiments, the present invention provides a method for preparing a composition for treatment of a subterranean formation. The method can be any suitable method that produces a composition described herein. For example, the method can include forming a composition including a particulate bridging agent and fibers.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### Additional Embodiments

The present invention provides for the following exemplary embodiments, the numbering of which is not to be construed as designating levels of importance:

Embodiment 1 provides a method of treating a subterranean formation, the method comprising: obtaining or providing a composition comprising a particulate bridging agent and fibers; placing the composition in a subterranean formation; and forming a bridging agent-fiber diverter from the composition within the formation.

Embodiment 2 provides the method of Embodiment 1, wherein the obtaining or providing of the composition occurs above-surface.

Embodiment 3 provides the method of any one of Embodiments 1-2, wherein the obtaining or providing of the composition occurs downhole.

Embodiment 4 provides the method of any one of Embodiments 1-3, wherein the forming of the bridging agent-fiber diverter occurs downhole.

Embodiment 5 provides the method of any one of Embodiments 1-4, wherein the composition is a hydraulic fracturing fluid.

Embodiment 6 provides the method of any one of Embodiments 1-5, wherein the composition further comprises a proppant.

Embodiment 7 provides the method of any one of Embodiments 1-6, wherein the method comprises a method of fluid loss control.

Embodiment 8 provides the method of any one of Embodiments 1-7, wherein the bridging agent-fiber diverter comprises a filter cake.

Embodiment 9 provides the method of any one of Embodiments 1-8, wherein placing the composition in the subterranean formation comprises placing the composition in at least one of an open-hole section, fracture, perforation, flow pathway, and an area surrounding the same.

Embodiment 10 provides the method of any one of Embodiments 1-9, wherein forming the bridging agent-fiber diverter comprises forming the diverter in at least one of an open-hole section, fracture, perforation, flow pathway, and an area surrounding the same.

Embodiment 11 provides the method of any one of Embodiments 1-10, further comprising degrading the bridging agent-fiber diverter.

Embodiment 12 provides the method of Embodiment 11 wherein degrading the bridging agent-fiber diverter comprises permitting the bridging agent to self-degrade.

Embodiment 13 provides the method of any one of Embodiments 11-12, wherein degrading provides substantially complete removal of the bridging agent-fiber diverter from the subterranean formation.

Embodiment 14 provides the method of any one of Embodiments 11-13, wherein degrading provides substantially complete removal of the bridging agent-fiber diverter from a fracture or flowpath where the diverter was formed.

Embodiment 15 provides the method of any one of Embodiments 11-14, wherein degrading substantially restores a pre-diverter-formation permeability to a fracture or flowpath where the bridging agent-fiber diverter was formed.

Embodiment 16 provides the method of any one of Embodiments 11-15, wherein the degrading is irreversible.

Embodiment 17 provides the method of any one of Embodiments 11-16, comprising triggering the degrading.

Embodiment 18 provides the method of Embodiment 17, wherein the triggering comprises at least one of allowing time to pass, heating, vibrating, changing surrounding pH, changing surrounding salinity, and changing surrounding chemical environment.

Embodiment 19 provides the method of any one of Embodiments 1-18, further comprising placing a downhole fluid in the subterranean formation after forming the bridging agent-fiber diverter.

Embodiment 20 provides the method of Embodiment 19, wherein the downhole fluid comprises an aqueous or oil-based fluid comprising a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.

Embodiment 21 provides the method of any one of Embodiments 19-20, wherein the bridging agent-fiber diverter substantially diverts the downhole fluid away from at least one of an open-hole section, fracture, perforation, and flow pathway where the diverter was formed.

Embodiment 22 provides the method of any one of Embodiments 1-21, further comprising using a fracturing fluid to hydraulically fracture the subterranean formation after forming the bridging agent-fiber diverter.

Embodiment 23 provides the method of Embodiment 22, wherein the bridging agent-fiber diverter substantially diverts the fracturing fluid away from at least one of an open-hole section, fracture, perforation, and flow pathway where the diverter was formed.

Embodiment 24 provides the method of Embodiment 23, wherein the bridging agent-fiber diverter diverts about 50 vol % to about 100 vol % of the fracturing fluid away from the open-hole section, fracture, perforation, or flow pathway where the diverter was formed.

Embodiment 25 provides the method of any one of Embodiments 1-24, further comprising placing an acid treatment composition in the subterranean formation after forming the bridging agent-fiber diverter.

Embodiment 26 provides the method of Embodiment 25, further comprising hydraulically fracturing the subterranean formation after placing the acid treatment composition in the subterranean formation.

Embodiment 27 provides the method of any one of Embodiments 1-26, wherein the fibers comprise at least one of vegetable fibers, wood fibers, human fibers, animal fibers, mineral fibers, metallic fibers, carbon fibers, silicon carbide fibers, fiberglass fibers, cellulose fibers, and polymer fibers.

Embodiment 28 provides the method of any one of Embodiments 1-27, wherein the fibers are non-self-degradable.

Embodiment 29 provides the method of any one of Embodiments 1-28, wherein the fibers comprise at least one of nylon fibers, polyethylene terephthalate fibers, poly(vinyl alcohol) fibers, polyolefin fibers, acrylic polyester fibers, aromatic polyamide fibers, elastomeric polymer fibers, and polyurethane fibers.

Embodiment 30 provides the method of any one of Embodiments 1-29, wherein the fibers comprise at least one of polyamide fibers, polyethylene fibers, polypropylene fibers, and glass fibers.

Embodiment 31 provides the method of any one of Embodiments 1-30, wherein the fibers have a length of about 2 mm to about 30 mm.

Embodiment 32 provides the method of any one of Embodiments 1-31, wherein the fibers have a diameter of about 10 μm to about 200 μm.

Embodiment 33 provides the method of any one of Embodiments 1-32, wherein the fibers are present in the composition in a concentration of about 0.10 g/L to about 60 g/L.

Embodiment 34 provides the method of any one of Embodiments 1-33, wherein the fibers are present in the composition in a concentration of about 0.50 g/L to about 30 g/L of the composition.

Embodiment 35 provides the method of any one of Embodiments 1-34, wherein the fibers have a density of about 0.5 g/cm³ to about 5 g/cm³.

Embodiment 36 provides the method of any one of Embodiments 1-35, wherein the fibers have a density of about 1 g/cm³ to about 4 g/cm³.

Embodiment 37 provides the method of any one of Embodiments 1-36, wherein the fibers comprise a lipophilic sizing agent.

Embodiment 38 provides the method of Embodiment 37, wherein the lipophilic sizing agent is non-polymeric.

Embodiment 39 provides the method of any one of Embodiments 37-38, wherein the lipophilic sizing agent comprises at least one of acetic anhydride, n-alkenyl isocyanate, a titanate, trichloro-s-triazine, and organosilanes having the structure (substituted or unsubstituted (C₁-C₃₀)hydrocarbyl)-Si—X₃, wherein X is independently selected from the group consisting of Cl, OMe, and OEt.

Embodiment 40 provides the method of any one of Embodiments 1-39, wherein the fibers comprise a lipophilic film-forming polymer.

Embodiment 41 provides the method of any one of Embodiments 37-40, wherein the lipophilic film-forming polymer comprises at least one of a polyurethane, polystyrene, polyvinyl chloride, a polyolefin, a polyester, an epoxy resin, and copolymers thereof.

Embodiment 42 provides the method of any one of Embodiments 1-41, wherein the fibers comprise at least one of a lubricant, an antistatic agent, an emulsifier, a wetting agent, and an antioxidant.

Embodiment 43 provides the method of any one of Embodiments 1-42, wherein the bridging agent is at least one of platelets, shavings, flakes, ribbons, rods, strips, spheroids, toroids, pellets, and tablets.

Embodiment 44 provides the method of any one of Embodiments 1-43, wherein the bridging agent comprises particles having a particle size of about 0.1 μm to about 10 mm.

Embodiment 45 provides the method of any one of Embodiments 1-44, wherein the bridging agent comprises particles having a particle size of about 0.1 to about 1 mm, and particles having a particle size of about 1 mm to about 10 mm.

Embodiment 46 provides the method of any one of Embodiments 1-45, wherein the bridging agent is about 0.01 wt % to about 60 wt % of the composition.

Embodiment 47 provides the method of any one of Embodiments 1-46, wherein the bridging agent is about 0.1 wt % to about 30 wt % of the composition.

Embodiment 48 provides the method of any one of Embodiments 1-47, wherein the bridging agent comprises a degradable polymer or a rehydratably-degradable compound.

Embodiment 49 provides the method of Embodiment 48, wherein the degradable polymer self-degrades under downhole conditions.

Embodiment 50 provides the method of any one of Embodiments 48-49, wherein the rehydratable-degradable compound self-degrades under downhole conditions upon hydration.

Embodiment 51 provides the method of any one of Embodiments 1-50, wherein the bridging agent comprises at least one polymer selected from the group consisting of a polysaccharide, chitin, chitosan, a protein, an orthoester, an aliphatic polyester, a polyglycolide, polylactide, poly(vinyl alcohol), an esterified poly(vinyl alcohol), polycaprolactone, polyhydroxybutyrate, a polyanhydride, an aliphatic polycarbonate, a polyorthoester, a poly(amino acid), a poly(ethylene oxide), and a polyphosphazene, or a copolymer including monomers from at least two polymers chosen from the group.

Embodiment 52 provides the method of any one of Embodiments 1-51, wherein the bridging agent comprises a polyester.

Embodiment 53 provides the method of any one of Embodiments 1-52, wherein the bridging agent comprises a polymer comprising a repeating unit having the structure

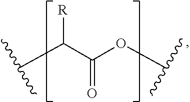

wherein at each occurrence R is independently a substituted or unsubstituted (C₁-C₃₀)hydrocarbyl at least one of interrupted and terminated by 0, 1, 2, or 3 of at least one of O, S, and substituted or unsubstituted N.

Embodiment 54 provides the method of Embodiment 53, wherein at each occurrence R is independently (C₁-C₁₀)alkyl.

Embodiment 55 provides the method of any one of Embodiments 53-54, wherein at each occurrence R is independently selected from the group consisting of methyl, ethyl, and propyl.

Embodiment 56 provides the method of any one of Embodiments 53-55, wherein R is methyl.

Embodiment 57 provides the method of any one of Embodiments 1-56, wherein the bridging agent is polylactide, polyglycolide, or a polylactide-polyglycolide copolymer.

Embodiment 58 provides the method of Embodiment 57, wherein the polylactide is poly-L-lactide.

Embodiment 59 provides the method of any one of Embodiments 57-58, wherein the polylactide is poly-D-lactide.

Embodiment 60 provides the method of any one of Embodiments 57-59, wherein the polylactide is poly(D,L-lactide).

Embodiment 61 provides the method of any one of Embodiments 1-60, wherein the bridging agent comprises a polymer comprising a repeating unit having the structure

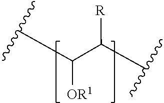

wherein at each occurrence R is independently a substituted or unsubstituted (C₁-C₃₀)hydrocarbyl at least one of interrupted and terminated by 0, 1, 2, or 3 of at least one of O, S, and substituted or unsubstituted N; at each occurrence R¹ is independently selected from the group consisting of H and —C(O)—R², wherein at each occurrence R² is independently substituted or unsubstituted (C₁-C₂₀)hydrocarbyl at least one of interrupted and terminated by 0, 1, 2, or 3 of at least one of O, S, and substituted or unsubstituted N.

Embodiment 62 provides the method of Embodiment 61, wherein at each occurrence R is independently (C₁-C₁₀)alkyl.

Embodiment 63 provides the method of any one of Embodiments 61-62, wherein R is H.

Embodiment 64 provides the method of any one of Embodiments 61-63, wherein at each occurrence R¹ is independently (C₁-C₁₀)alkyl.

Embodiment 65 provides the method of any one of Embodiments 1-64, wherein the bridging agent comprises at least one of poly(vinyl alcohol), poly(vinyl acetate), poly(vinyl propanoate), poly(vinyl butanoate), poly(vinyl pentanoate), poly(vinyl hexanoate), poly(vinyl 2-methyl butanoate), poly(vinyl 3-ethylpentanoate), and poly(vinyl 3-ethylhexanoate).

Embodiment 66 provides the method of any one of Embodiments 1-65, wherein the bridging agent comprises at least one of sodium borate, boric oxide, calcium carbonate, and magnesium oxide.

Embodiment 67 provides the method of any one of Embodiments 1-66, wherein the bridging agent comprises a polyanhydride selected from the group consisting of poly(maleic anhydride), acetic formic anhydride, a poly((C₁-C₂₀)alkenoic(C₁-C₂₀)alkanoic anhydride) anhydride, a poly((C₁-C₂₀)alkenoic(C₁-C₂₀)alkenoic anhydride), poly(propenoic acid anhydride), poly(butenoic acid anhydride), poly(pentenoic acid anhydride), poly(hexenoic acid anhydride), poly(octenoic acid anhydride), poly(nonenoic acid anhydride), poly(decenoic acid anhydride), poly(acrylic acid anhydride), poly(fumaric acid anhydride), poly(methacrylic acid anhydride), poly(hydroxypropyl acrylic acid anhydride), poly(vinyl phosphonic acid anhydride), poly(vinylidene diphosphonic acid anhydride), poly(itaconic acid anhydride), poly(crotonic acid anhydride), poly(mesoconic acid anhydride), poly(citraconic acid anhydride), poly(styrene sulfonic acid anhydride), poly(allyl sulfonic acid anhydride), poly(methallyl sulfonic acid anhydride), or poly(vinyl sulfonic acid anhydride).

Embodiment 68 provides the method of any one of Embodiments 1-67, wherein the bridging agent comprises a rehydratably degradable compound selected from the group consisting of anhydrous borax and anhydrous boric acid.

Embodiment 69 provides the method of any one of Embodiments 1-68, wherein the composition comprises a plasticizer.

Embodiment 70 provides the method of Embodiment 69, wherein the plasticizer is an oligomeric polyester.

Embodiment 71 provides the method of any one of Embodiments 69-70, wherein the plasticizer is oligomeric lactic acid.

Embodiment 72 provides the method of any one of Embodiments 1-71, wherein the composition comprises a carrier fluid.

Embodiment 73 provides the method of Embodiment 72, wherein the carrier fluid comprises at least one of water, brine, sea water, brackish water, flow back water, production water, oil, and an organic solvent.

Embodiment 74 provides the method of any one of Embodiments 72-73, wherein the carrier fluid is about 60-99 wt % of the composition.

Embodiment 75 provides the method of any one of Embodiments 72-74, wherein the carrier fluid is about 85-99 wt % of the composition.

Embodiment 76 provides the method of any one of Embodiments 1-75, wherein the composition further comprises a gel or crosslinked gel.

Embodiment 77 provides the method of Embodiment 76, wherein the gel or crosslinked gel comprises at least one of a linear polysaccharide and a poly((C₂-C₁₀)alkenylene), wherein the (C₂-C₁₀)alkenylene is substituted or unsubstituted.

Embodiment 78 provides the method of any one of Embodiments 76-77, wherein the gel or crosslinked gel comprises poly(acrylic acid) or (C₁-C₅)alkyl esters thereof, poly(methacrylic acid) or (C₁-C₅)alkyl esters thereof, poly(vinyl acetate), poly(vinyl alcohol), poly(ethylene glycol), poly(vinyl pyrrolidone), polyacrylamide, poly(hydroxyethyl methacrylate), acetan, alginate, chitosan, curdlan, a cyclosophoran, dextran, emulsan, a galactoglucopolysaccharide, gellan, glucuronan, N-acetyl-glucosamine, N-acetyl-heparosan, hyaluronic acid, indicant, kefiran, lentinan, levan, mauran, pullulan, scleroglucan, schizophyllan, stewartan, succinoglycan, xanthan, welan, starch, tamarind, tragacanth, guar gum, derivatized guar, gum ghatti, gum arabic, locust bean gum, cellulose, and derivatized cellulose.

Embodiment 79 provides the method of any one of Embodiments 76-78, wherein the gel or crosslinked gel comprises cellulose, carboxymethyl cellulose, hydroxyethyl cellulose, carboxymethyl hydroxyethyl cellulose, hydroxypropyl cellulose, methyl hydroxyl ethyl cellulose, guar, hydroxypropyl guar, carboxy methyl guar, and carboxymethyl hydroxylpropyl guar.

Embodiment 80 provides the method of any one of Embodiments 76-79, wherein the gel or crosslinked gel is about 0.001 wt % to about 10 wt % of the composition.

Embodiment 81 provides the method of any one of Embodiments 76-80, wherein the gel or crosslinked gel is about 0.01 wt % to about 0.6 wt %.

Embodiment 82 provides the method of any one of Embodiments 1-81, wherein the composition comprises a crosslinker.

Embodiment 83 provides the method of Embodiment 82, wherein the crosslinker comprises at least one of chromium, aluminum, antimony, zirconium, titanium, calcium, boron, iron, silicon, copper, zinc, magnesium, and an ion thereof.

Embodiment 84 provides the method of any one of Embodiments 82-83, wherein the crosslinker comprises at least one of boric acid, borax, a borate, a (C₁-C₃₀)hydrocarbylboronic acid, a (C₁-C₃₀)hydrocarbyl ester of a (C₁-C₃₀)hydrocarbylboronic acid, a (C₁-C₃₀)hydrocarbylboronic acid-modified polyacrylamide, ferric chloride, disodium octaborate tetrahydrate, sodium metaborate, sodium diborate, sodium tetraborate, disodium tetraborate, a pentaborate, ulexite, colemanite, magnesium oxide, zirconium lactate, zirconium triethanol amine, zirconium lactate triethanolamine, zirconium carbonate, zirconium acetylacetonate, zirconium malate, zirconium citrate, zirconium diisopropylamine lactate, zirconium glycolate, zirconium triethanol amine glycolate, and zirconium lactate glycolate, titanium lactate, titanium malate, titanium citrate, titanium ammonium lactate, titanium triethanolamine, titanium acetylacetonate, aluminum lactate, and aluminum citrate.

Embodiment 85 provides the method of any one of Embodiments 82-84, wherein the crosslinker is about 0.000.001 wt % to about 5 wt % of the composition.

Embodiment 86 provides the method of any one of Embodiments 82-85, wherein the crosslinker is about 0.001 wt % to about 2 wt % of the composition.

Embodiment 87 provides the method of any one of Embodiments 82-86, further comprising crosslinking a gel or crosslinked gel.

Embodiment 88 provides the method of Embodiment 87, wherein the crosslinking occurs at least one of above-surface, downhole, and a combination thereof.

Embodiment 89 provides the method of any one of Embodiments 1-88, wherein above-surface the composition has a viscosity at standard temperature and pressure of about 0.01 cP to about 15,000 cP.

Embodiment 90 provides the method of any one of Embodiments 1-89, wherein above-surface the composition has a viscosity at standard temperature and pressure of about 0.02 cP to about 1,500 cP.

Embodiment 91 provides the method of any one of Embodiments 1-90, wherein the composition comprises a fluid loss control additive.

Embodiment 92 provides the method of Embodiment 91, wherein the fluid loss control additive comprises at least one of starch, starch ether derivatives, hydroxyethylcellulose, and cross-linked hydroxyethyl cellulose.

Embodiment 93 provides the method of any one of Embodiments 91-92, wherein the fluid loss control additive is about 0.001 wt % to about 10 wt % of the composition.

Embodiment 94 provides the method of any one of Embodiments 91-93, wherein the fluid loss control additive is about 0.01 wt % to about 3 wt % of the composition.

Embodiment 95 provides the method of any one of Embodiments 1-94, wherein the composition further comprises a breaker, wherein upon degradation of the bridging agent-fiber diverter the breaker is released.

Embodiment 96 provides the method of Embodiment 95, wherein the breaker comprises at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a chloride, fluoride, bromide, phosphate, or sulfate ion.

Embodiment 97 provides the method of any one of Embodiments 95-96, wherein the breaker is about 0.001 wt % to about 30 wt % of the composition.

Embodiment 98 provides the method of any one of Embodiments 95-97, wherein the breaker comprises at least one of an oxidative breaker and an enzymatic breaker.

Embodiment 99 provides the method of Embodiment 98, wherein the oxidative breaker comprises at least one of a Na⁺, K⁺, Li⁺, Zn⁺, NH₄⁺, Fe²⁺, Fe³⁺, Cu¹⁺, Cu²⁺, Ca²⁺, Mg²⁺, Zn²⁺, and an Al³⁺ salt of a persulfate, percarbonate, perborate, peroxide, perphosphosphate, permanganate, chlorite, or hyperchlorite ion.

Embodiment 100 provides the method of any one of Embodiments 98-99, wherein the enzymatic breaker comprises at least one of an alpha or beta amylase, amyloglucosidase, oligoglucosidase, invertase, maltase, cellulase, hemi-cellulase, and mannanohydrolase.

Embodiment 101 provides the method of any one of Embodiments 1-100, wherein the composition further comprises a tackifying agent.

Embodiment 102 provides the method of Embodiment 101, wherein the composition comprises the tackifying agent in an amount of about 0.001 wt % to about 30 wt % of the bridging agent.

Embodiment 103 provides the method of any one of Embodiments 101-102, wherein the composition comprises the tackifying agent in an amount of about 0.01 wt % to about 15 wt % of the bridging agent.

Embodiment 104 provides the method of any one of Embodiments 101-103, wherein the tackifying agent comprises a thermoplastic material comprising at least one of a polyolefin, a polyamide, a polyvinyl compound, a polyimide, a polyurethane, a polysulfone, a polycarbonate, a polyester, and a cellulose derivative.

Embodiment 105 provides the method of any one of Embodiments 101-104, wherein the tackifying agent comprises a thermoplastic material comprising at least one of polyethylene polymer, copolymer or a fluorinated derivative thereof, a polypropylene polymer, copolymer, or a fluorinated derivative thereof, and a polybutylene polymer, copolymer, or a fluorinated derivative thereof.

Embodiment 106 provides the method of any one of Embodiments 101-105, wherein the tackifying agent comprises a non-aqueous tackifying agent, an aqueous tackifying agent, a silyl-modified polyamide, and a reaction product of an amine and a phosphate ester.

Embodiment 107 provides the method of any one of Embodiments 1-106, further comprising combining the composition with an aqueous or oil-based fluid comprising a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof, to form a mixture, wherein the placing the composition in the subterranean formation comprises placing the mixture in the subterranean formation.

Embodiment 108 provides the method of any one of Embodiments 1-107, wherein the composition further comprises water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement fly ash, metakaolin, shale, zeolite, a crystalline silica compound, amorphous silica, fibers, a hydratable clay, microspheres, pozzolan lime, or a combination thereof.

Embodiment 109 provides the method of any one of Embodiments 1-108, wherein the composition further comprises a proppant, a resin-coated proppant, an encapsulated resin, or a combination thereof.

Embodiment 110 provides the method of any one of Embodiments 1-109, wherein the composition further comprises a payload material.

Embodiment 111 provides the method of Embodiment 110, further comprising using the composition to deposit at least part of the payload material downhole.

Embodiment 112 provides the method of Embodiment 111, wherein the at least part of the payload material is deposited in a subterranean fracture.

Embodiment 113 provides the method of any one of Embodiments 110-112, wherein the payload material comprises a proppant, a resin-coated proppant, a curable material, an encapsulated resin, a resin, a Portland cement, a pozzolana cement, a gypsum cement, a high alumina content cement, a slag cement, a silica cement, a cementitous kiln dust, fly ash, metakaolin, shale, zeolite, a set retarding additive, a surfactant, a gas, an accelerator, a weight reducing additive, a heavy-weight additive, a lost circulation material, a filtration control additive, a dispersant, a crystalline silica compound, an amorphous silica, a salt, a fiber, a hydratable clay, a microsphere, pozzolan lime, a thixotropic additive, water, an aqueous base, an aqueous acid, an alcohol or polyol, a cellulose, a starch, an alkalinity control agent, a density control agent, a density modifier, a surfactant, an emulsifier, a dispersant, a polymeric stabilizer, a crosslinking agent, a polyacrylamide, a polymer or combination of polymers, an antioxidant, a heat stabilizer, a foam control agent, a solvent, a diluent, a plasticizer, a filler or inorganic particle, a pigment, a dye, a precipitating agent, a rheology modifier, or a combination thereof.

Embodiment 114 provides a method of treating a subterranean formation, the method comprising: obtaining or providing a composition comprising a particulate bridging agent, fibers, and a proppant; placing the composition in a subterranean formation.

Embodiment 115 provides a method of hydraulic fracturing, the method comprising: obtaining or providing a composition comprising a self-degrading particulate bridging agent and fibers; placing the composition in a subterranean formation; forming a bridging agent-fiber self-degrading diverter from the composition within the formation, comprising forming the diverter in at least one of an open-hole section, fracture, perforation, flow pathway, and an area surrounding the same; placing a hydraulic fracturing fluid in the subterranean formation and performing a hydraulic fracturing operation therewith, wherein during the hydraulic fracturing operation the bridging agent-fiber diverter substantially diverts the fracturing fluid away from the open-hole section, fracture, perforation, or flow pathway; and allowing the diverter to self-degrade.

Embodiment 116 provides a system comprising: a composition comprising a particulate bridging agent and fibers; and a subterranean formation comprising the composition therein.

Embodiment 117 provides a system comprising: a bridging agent-fiber diverter; and a subterranean formation comprising the diverter therein.

Embodiment 118 provides a composition for treatment of a subterranean formation, the composition comprising a particulate bridging agent and fibers.

Embodiment 119 provides the composition of Embodiment 118, wherein the composition further comprises a downhole fluid.

Embodiment 120 provides the composition of any one of Embodiments 118-119, wherein the composition is a composition for fracturing of a subterranean formation.

Embodiment 121 provides a diverter for fluid loss control in a subterranean formation, comprising a bridging agent-fiber diverter.

Embodiment 122 provides a method of preparing a composition for treatment of a subterranean formation, the method comprising: forming a composition comprising a particulate bridging agent and fibers.

Embodiment 123 provides the apparatus or method of any one or any combination of Embodiments 1-122 optionally configured such that all elements or options recited are available to use or select from.

1-122. (canceled)

123. A method of treating a subterranean formation, the method comprising:
placing in the subterranean formation a composition comprising a particulate bridging agent and fibers; and
forming a bridging agent-fiber diverter from the composition within the subterranean formation.

124. The method of claim 123, wherein the composition is a hydraulic fracturing fluid.

125. The method of claim 123, wherein the composition further comprises a proppant.

126. The method of claim 123, further comprising degrading the bridging agent-fiber diverter.

127. The method of claim 123, further comprising using a fracturing fluid to hydraulically fracture the subterranean formation after forming the bridging agent-fiber diverter.

128. The method of claim 123, further comprising placing an acid treatment composition in the subterranean formation after forming the bridging agent-fiber diverter.

129. The method of claim 123, wherein the fibers comprise at least one of vegetable fibers, wood fibers, human fibers, animal fibers, mineral fibers, metallic fibers, carbon fibers, silicon carbide fibers, fiberglass fibers, cellulose fibers, and polymer fibers.

130. The method of claim 123, wherein the fibers comprise at least one of polyamide fibers, nylon fibers, polyethylene fibers, polypropylene fibers, polyethylene terephthalate fibers, poly(vinyl alcohol) fibers, polyolefin fibers, acrylic polyester fibers, aromatic polyamide fibers, elastomeric polymer fibers, glass fibers, and polyurethane fibers.

131. The method of claim 123, wherein the bridging agent is at least one of platelets, shavings, flakes, ribbons, rods, strips, spheroids, toroids, pellets, and tablets.

132. The method of claim 123, wherein the bridging agent comprises a degradable polymer or a rehydratably-degradable compound.

133. The method of claim 123, wherein the bridging agent comprises at least one polymer selected from the group consisting of a polysaccharide, chitin, chitosan, a protein, an orthoester, an aliphatic polyester, a polyglycolide, polylactide, poly(vinyl alcohol), an esterified poly(vinyl alcohol), polycaprolactone, polyhydroxybutyrate, a polyanhydride, an aliphatic polycarbonate, a polyorthoester, a poly(amino acid), a poly(ethylene oxide), and a polyphosphazene, or a copolymer including monomers from at least two polymers chosen from the group.

134. The method of claim 123, wherein the bridging agent comprises a polyester.

135. The method of claim 123, wherein the bridging agent is polylactide, polyglycolide, or a polylactide-polyglycolide copolymer.

136. The method of claim 123, wherein the bridging agent comprises a polymer comprising a repeating unit having the structure 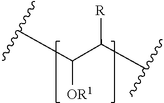
wherein at each occurrence R is independently a substituted or unsubstituted (C₁-C₃₀)hydrocarbyl at least one of interrupted and terminated by 0, 1, 2, or 3 of at least one of O, S, and substituted or unsubstituted N;
at each occurrence R¹ is independently selected from the group consisting of H and —C(O)—R², wherein at each occurrence R² is independently substituted or unsubstituted (C₁-C₂₀)hydrocarbyl at least one of interrupted and terminated by 0, 1, 2, or 3 of at least one of O, S, and substituted or unsubstituted N.

137. The method of claim 123, wherein the bridging agent comprises at least one of poly(vinyl alcohol), poly(vinyl acetate), poly(vinyl propanoate), poly(vinyl butanoate), poly(vinyl pentanoate), poly(vinyl hexanoate), poly(vinyl 2-methyl butanoate), poly(vinyl 3-ethylpentanoate), and poly(vinyl 3-ethylhexanoate).

138. The method of claim 123, wherein the bridging agent comprises at least one of sodium borate, boric oxide, calcium carbonate, and magnesium oxide.

139. The method of claim 123, wherein the bridging agent comprises a polyanhydride selected from the group consisting of poly(maleic anhydride), acetic formic anhydride, a poly((C₁-C₂₀)alkenoic(C₁-C₂₀)alkanoic anhydride) anhydride, a poly((C₁-C₂₀)alkenoic(C₁-C₂₀)alkenoic anhydride), poly(propenoic acid anhydride), poly(butenoic acid anhydride), poly(pentenoic acid anhydride), poly(hexenoic acid anhydride), poly(octenoic acid anhydride), poly(nonenoic acid anhydride), poly(decenoic acid anhydride), poly(acrylic acid anhydride), poly(fumaric acid anhydride), poly(methacrylic acid anhydride), poly(hydroxypropyl acrylic acid anhydride), poly(vinyl phosphonic acid anhydride), poly(vinylidene diphosphonic acid anhydride), poly(itaconic acid anhydride), poly(crotonic acid anhydride), poly(mesoconic acid anhydride), poly(citraconic acid anhydride), poly(styrene sulfonic acid anhydride), poly(allyl sulfonic acid anhydride), poly(methallyl sulfonic acid anhydride), or poly(vinyl sulfonic acid anhydride).

140. The method of claim 123, wherein the bridging agent comprises a rehydratably degradable compound selected from the group consisting of anhydrous borax and anhydrous boric acid.

141. A method of hydraulic fracturing, the method comprising:
obtaining or providing a composition comprising a self-degrading particulate bridging agent and fibers;
placing the composition in a subterranean formation;
forming a bridging agent-fiber self-degrading diverter from the composition within the formation, comprising forming the diverter in at least one of an open-hole section, fracture, perforation, flow pathway, and an area surrounding the same;
placing a hydraulic fracturing fluid in the subterranean formation and performing a hydraulic fracturing operation therewith, wherein during the hydraulic fracturing operation the bridging agent-fiber diverter substantially diverts the fracturing fluid away from the open-hole section, fracture, perforation, or flow pathway; and
allowing the diverter to self-degrade.

142. A system comprising:
a tubular disposed in a subterranean formation; and
a pump configured to pump a composition comprising a particulate bridging agent and fibers in the subterranean formation through the tubular.
